(19) United States
(12) Patent Application Publication
(10) Pub. No.: US 2006/0080271 A1
(43) Pub. Date: Apr. 13, 2006

(54) Dynamic reporting tool for a fact warehouse, a fact contained within the fact warehouse, and a method for refreshing the fact warehouse

(76) Inventors: Jeff Williams, Grand Rapids, MI (US); Matthew L. Hahnfeld, Grand Rapids, MI (US); Benjamin J. Mouw, Grand Rapids, MI (US); Paul Tjapkes, Nunica, MI (US); Eric A. Richter, Wyoming, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/961,897

(22) Filed: Oct. 8, 2004

(51) Int. Cl. G06F 17/30

(52) U.S. Cl. 707/1

(57) ABSTRACT

A database for an enterprise includes a data warehouse and a fact warehouse. The fact warehouse contains facts determined at least in part from data contained within the data warehouse. A fact contained within the data warehouse includes information and a reference depth attribute. The reference depth attribute is indicative of the dependencies of the fact on other facts within the fact warehouse. A database tool is provided for creating facts. A fact set tool is also provided for creating summary screens for displaying the facts.

### RELATED APPLICATIONS

This application incorporates by reference an application entitled “HEALTH CARE SYSTEM AND METHOD OF OPERATING A HEALTH CARE SYSTEM” assigned to the assignee of this application, patent application Ser. No. ______.

### BACKGROUND OF THE INVENTION

Databases have proven to be immensely valuable to operating businesses. Various tools have been designed to extract the data within the database. The data as maintained within the database, however, must usually be refined, augmented or filtered in order to produce meaningful metrics and information for operation and analysis of an enterprise.

For example, in a health care system, data may include the date of specific prescription purchases by a participant in the health care system. The health care system can identify whether the participant is endangering himself by analyzing that data as well as other information such as the type of drug purchased, the dates of other drug purchases, and the doctor or doctors prescribing the drug,

A database programmer could write a specific set of instructions to obtain such information directly from the central database warehouse. However, depending upon several factors such as the complexity of the instruction and the number of persons extracting the information, such a process may be inefficient and time consuming.

Fact tables or summary tables are sometimes used. Fact tables contain essential information which can be used to summarize the operation of an enterprise. Fact tables provide an efficient means to access important information about an enterprise. Fact tables generally have a limited amount of information and can be organized in a way to facilitate access by people without advanced database management skills.

The fact tables themselves are often developed by a database programmer with extensive knowledge of the database design. Thus, when an organization desires to change the fact table by adding, deleting or modifying facts, a skilled database programmer must be used.

An improved method and system for managing the access to the information available from a data warehouse is thus highly desirable.

### SUMMARY OF THE INVENTION

A database for an enterprise includes a data warehouse and a fact warehouse. The fact warehouse contains facts determined at least in part from data contained within the data warehouse. A fact contained within the data warehouse includes information and reference depth attribute. The reference depth attribute is indicative of the dependencies of the fact on other facts within the fact warehouse

A tool for creating facts within the database includes a code box containing database code such as SQL, a public name, a fact description, and a context name. The tool may also include a fact data type and a fact entity type. A refresh period is provided to indicate when the fact should be refreshed.

An indicator is provided to show whether the database code is valid. A second indicator shows whether the SQL for any fact referenced within the particular fact definition is valid.

A method of calculating a reference depth consists of retrieving the reference depth for a referenced fact. If reference depths for all facts have not been retrieved, then the reference depth for the next fact is retrieved. Once all reference depths have been retrieved, then highest reference depth is found. The reference depth of the current fact is set to one more than the highest reference depth of the facts.

These and other objects, advantages and features of the invention will be more readily understood and appreciated by reference to the detailed description of the drawings.

### BRIEF DESCRIPTION OF THE DRAWINGS

FIG. 1 shows a health care system.

FIG. 2 is a more detailed view of a fact.

FIG. 3 shows a database tool for creating facts.

FIG. 4 shows a method of calculating a reference depth.

FIG. 5 shows the creation of a fact filter with the database tool shown in FIG. 3.

FIG. 6 shows the creation of a fact formula with the database tool shown in FIG. 3.

FIG. 7 shows a summary of a fact set.

FIG. 8 shows a tool for creating a fact set.

FIG. 9 shows another feature of the tool for creating a fact.

### DETAILED DESCRIPTION OF THE DRAWINGS

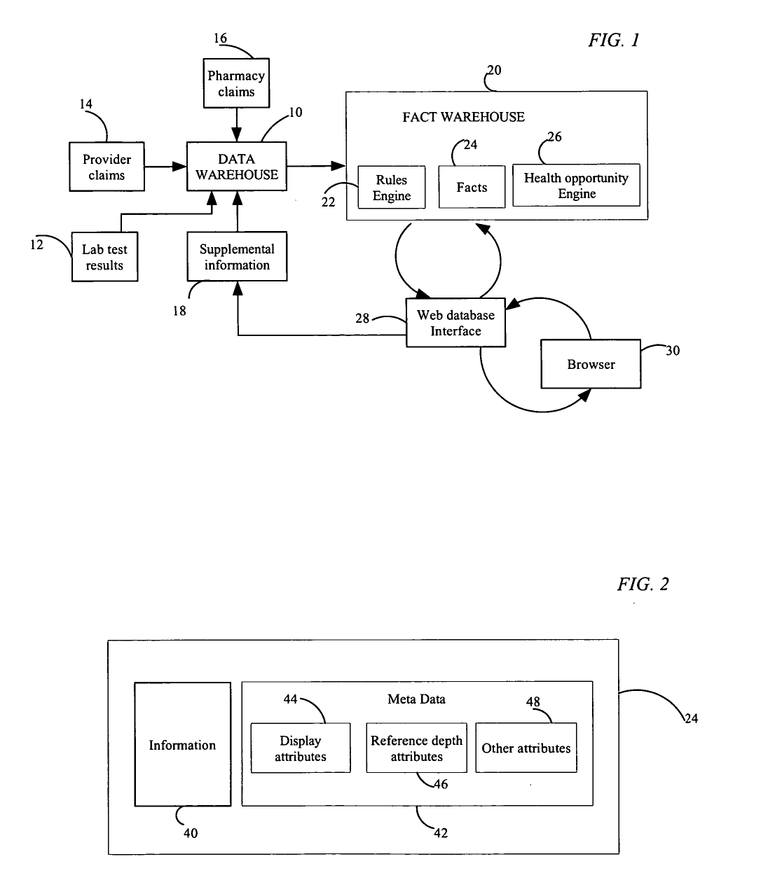

FIG. 1 shows a health care system. Data warehouse 10 receives data from various sources. In this example, data warehouse 10 receives data from lab test results 12, provider claims 14, and pharmacy claims 16. Data warehouse 10 also receives supplemental data 18.

Fact warehouse 20 extracts the data from data warehouse 10. Fact warehouse 20 includes a rules engine 22 for parsing the data from data warehouse 10 into facts 24 stored within fact warehouse 20. Health opportunities engine 26 analyzes facts 24 as well as data from data warehouse 10 to develop health opportunities for participants in the health care system.

A care opportunity is a proactive step by a participant or a provider to improve the health of a participant. For example, current health practices encourage that a diabetic have a lipid test every twelve months. Thus, the lipid test is a care opportunity for a participant with diabetes. Health opportunities for specific participants can be stored within fact warehouse 20.

Web database interface 28 manages requests for information from fact warehouse 20 made by browser 30. Web database interface 28 receives the information from fact warehouse 20, formats the information for display by browser 30 and then sends the formatted information to browser 30.

Fact warehouse 20 and data warehouse 10 could be contained within separate computers or a single computer. The computer would have a memory and one or more processors. The computer could have a large, long term storage memory as well as a volatile short term memory, such as random access memory. Web database interface 28 could be a web server, which could also be a computer having a memory and one or more processors.

Fact warehouse 20, data warehouse 10, web database interface 28 and browser 30 could communicate by way of a network. If so, then the various communications between fact warehouse 20, data warehouse 10, web database interface 28 and browser 30 would be encoded on signals transmitted by way of the network. The various commands and information exchanged between fact warehouse 20, data warehouse 10, web database interface 28 and browser 30 would be encoded within the electronic signals.

Fact warehouse 20 and data warehouse 10 are both databases. However, there are distinctions between the two. Data warehouse 10 is a relational database, while fact warehouse 20 is an entity inheritance database. Data warehouse 10 is populated one row at a time while fact warehouse 20 is populated one column at a time. Data warehouse 10 is populated only by external data sources, while fact warehouse 20 is populated both from an external source as well as from information generated by fact warehouse 20.

The sparsity (i.e., the number of nulls within a database) of fact warehouse 20 is relatively high while the sparsity of data warehouse is relatively low. The indexing of fact warehouse 20 is relatively high while the indexing of data warehouse 10 is lower. Relationships within data warehouse 10 are simple, while those within fact warehouse 20 can be complex and computational.

Updates of data warehouse 10 are incremental. Changes are propagated throughout the database. Fact warehouse 20 is refreshed in large parts. Various segments of fact warehouse 20 can be updated at different times. Updates to data warehouse 10 are by row, while those to fact warehouse 20 are by column.

FIG. 2 is a more detailed view of fact 24. Fact 24 is composed of information 40 and meta data 42. Information 40 could be developed by rules engine 22 or it could be data directly from data warehouse 10 that is stored within fact warehouse 20. Fact 24 also includes meta data 42.

Meta data 42 consists of display attributes 44, reference depth attributes 46 and other attributes 48. Display attributes 44 contain instructions for the display of the fact by web database interface 28. For example, display attributes 44 could include the font, style, size, and position to be used to display information 40, as well as hierarchical guidance regarding the display of information 40.

Reference depth attributes 46 contain all the dependencies for fact 24. Dependency attributes 46 indicates references to other facts or data within fact warehouse 20 which are precursors to before fact 24 can be identified.

An example is if fact 24 were a care opportunity for a twelve month lipid test. Before ascertaining whether that care opportunity exists, rules engine 22 must first determine whether the participant is a diabetic. If the participant is a diabetic, then rules engine 22 must then determine whether the participant had a lipid test, and if so, whether the lipid test was within the last twelve months.

Other attributes 48 include such information as the type of fact, the entity type, the refresh period, and the public name used for the fact.

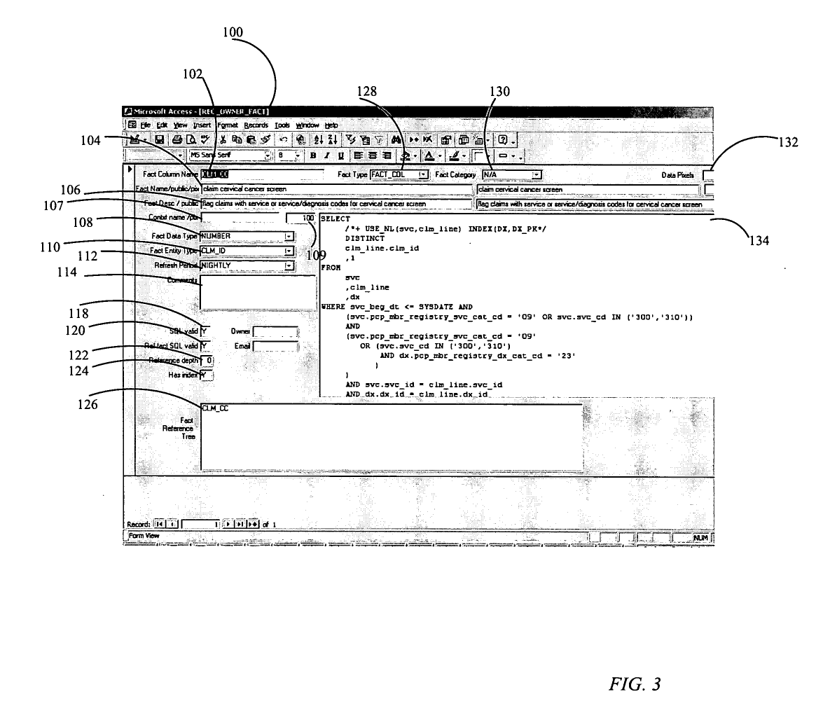

FIG. 3 shows database tool 100 for working with facts contained within the fact warehouse 20. Database tool 100 allows for entry of the various items necessary to define facts within fact warehouse 20.

FIG. 3 shows database tool 100 defining a fact column within fact warehouse 20. As is well known, databases include, among other things, a variety of rows and columns. Fact column name 102 is the internal name for a fact column. As is also well known, the internal name used by a database is often confusing. Public name 106 shows the common public name for the fact column. Public name 106 is intended to be a more understandable name for general use by persons unfamiliar with the structure of fact warehouse 20. Fact description 106 is a description of the fact.

Context name 107 is a name of the item which is descriptive when the fact is viewed within context. Context name pixel 109 is the number of pixels allocated to display of the context name. Fact data type 108 is the type of fact, such as a number or text. Fact entity type 110 defines the type of entity.

Refresh period 112 indicates the time for refreshing the fact column. A refresh is when the fact is repopulated. Refresh period 112 can be different for each fact. Comments 114 contain comments about the fact.

SQL valid 118 refers to whether the SQL code of SQL code box 134 is valid. SQL valid 118 could be determined during compilation of the SQL within SQL code box 134, or the syntax could be checked interactively. Reference fact SQL valid 120 refers to whether the SQL code of any facts referenced by the SQL code within SQL code box 134 is valid. Thus, a user is informed of the status of the SQL code of any facts referenced by the SQL code within SQL code box 134.

Has index 124 allows a user to require the system to develop an index for the particular fact. If the box is marked “Y”, then the system creates an index for the fact. If the box is “N”, then the system does not create an index, and, if one has been previously created for the fact, then deletes the index.

Reference depth box 122 and fact reference tree 126 work in tandem with refresh period 112. The contents of a fact may depend upon other facts within fact warehouse 20. Thus, in order to refresh a particular fact, all other facts it depends upon must be refreshed first. In order to accomplish the refreshing of dependencies, the tool tracks the reference depth of the SQL code within SQL code box 134 by calculating a reference depth. The reference depth is displayed with reference depth box 122.

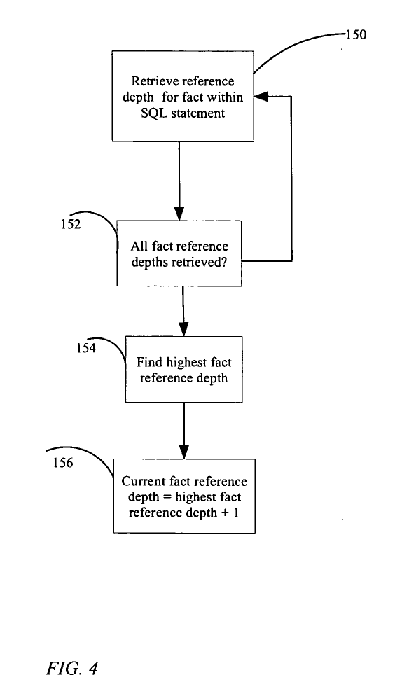

FIG. 4 shows a method of calculating a reference depth. The reference depth for a fact within SQL code box 134 is retrieved. Step 150. If reference depths for all facts have not been retrieved (step 152), then the reference depth for the next fact is retrieved. Step 150. If all reference depths have been retrieved, then highest reference depth is found. Step 154. The reference depth of the current fact is set to one more than the highest reference depth of the facts. Step 156.

For example, if fact A depended upon facts B, C and D, and the reference depth of fact B is 3, the reference depth of fact C is 4 and the reference depth of fact D is 5, then the reference depth of fact A is set to 6.

The reference depth indicates the dependency of a fact upon other facts. A fact with a reference depth of zero indicates that the fact is dependent upon no other facts with fact warehouse 20. A fact with a reference depth of one indicates that the fact depends only upon facts with a dependency of zero. A fact with a reference depth of two indicates that the fact is dependent upon facts with a maximum reference depth of one. A fact with a reference depth of three indicates that the fact is dependent upon facts with a maximum reference depth of two, and a fact with a reference depth of four indicates that the fact is dependent upon facts with a maximum reference depth of three, and so on.

The importance of reference depths is reflected in the method used to refresh fact warehouse 20 is done completely at regular intervals, such as one week. The facts within fact warehouse 20 are refreshed in accordance with reference depth.

Facts with a reference depth of zero are refreshed first. Facts with a reference depth of one are next refreshed. Since facts with a reference depth of one depend upon facts with a reference depth of zero, such facts can be refreshed without concern for dependency problems. Facts with a reference depth of two are refreshed after facts with a reference depth of one, followed by facts with a reference depth of three, and so on. In this way, fact warehouse 20 is refreshed in segments until all facts within fact warehouse 20 are refreshed.

Because all facts within fact warehouse 20 have an associated reference depth and the reference depth is automatically calculated based upon the reference depth of facts used in defining any fact, a user does not need to be concerned about refreshes and dependencies when designing a fact. Thus, a person with a limited knowledge of a database language can design a fact for fact warehouse 20. This allows many people to define facts for fact warehouse 20, allowing fact warehouse 20 to fulfill many different requirements and allowing users to tailor fact warehouse 20 to meet their needs.

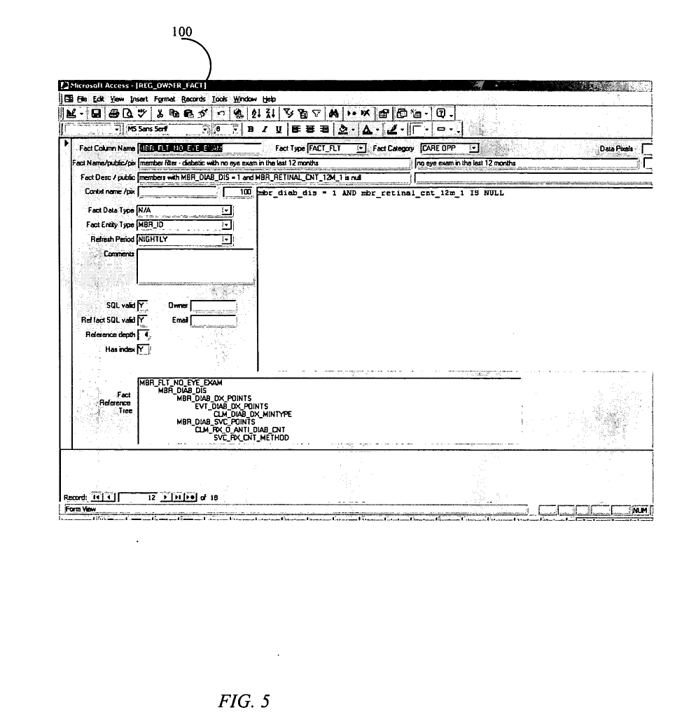

As shown in FIG. 5, database tool 100 can be used to create a fact filter for fact warehouse 20. A fact filter corresponds to a “WHERE” statement in the SQL database language.

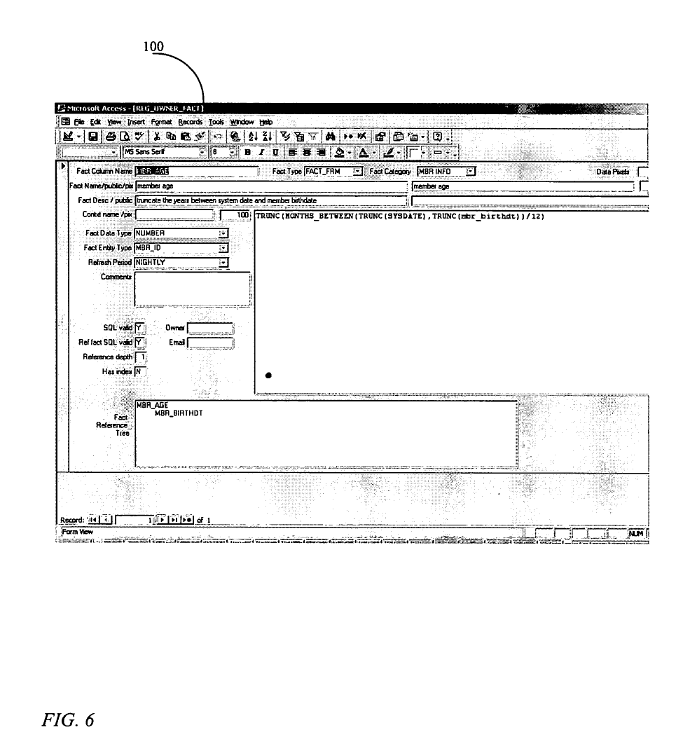

FIG. 6 shows the creation of a fact formula with database tool 100. A fact formula is a calculation based on fact data values. For example, a fact formula calculates the age of a participant by using a fact containing the birth date of the participant and a fact containing the current date.

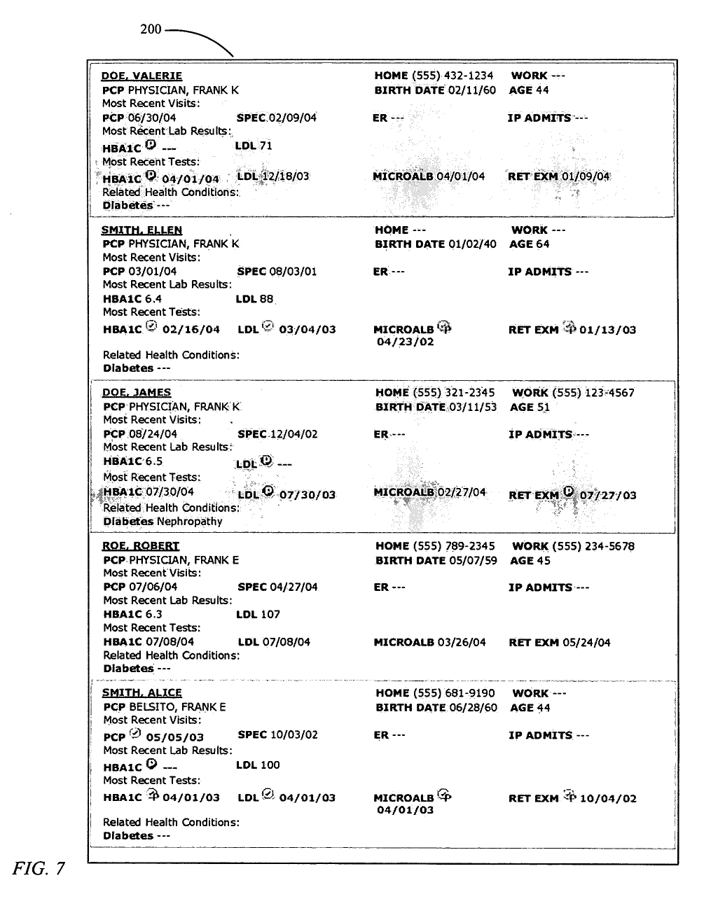

FIG. 7 shows fact set summary 200. Fact set summary 200 is a summary of fact objects derived from fact columns, fact filters and fact formulas. Fact set summary 200 could be about any thing within fact warehouse 20. The fact set provides a method of management of the facts needed for a particular application. By archiving fact sets, fact sets provides a convenient way to manage archiving of versions of facts.

A fact set usually includes a fact filter that selects the entities reported on by the fact set and may include additional optional filters. A fact set may include facts and/or fact formulas, and may provide conditional display of fact or fact formula values.

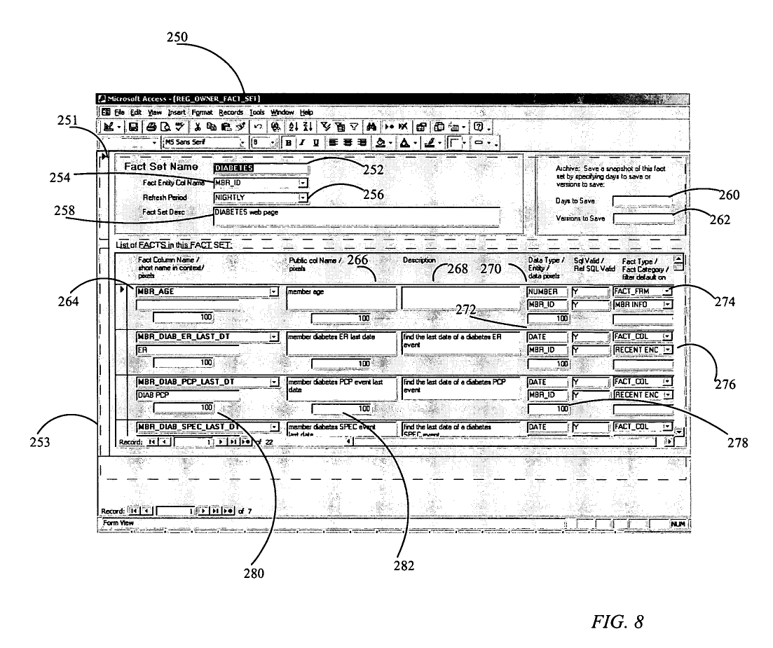

FIG. 8 shows fact set tool 250. Fact set tool 250 assists in the creation of fact sets such as the one shown in FIG. 7. Fact set tool 250 consists of general information area 251 and fact information area 253.

General information area 251 contains information of general applicability to the fact set. Fact set name 252 contains the name of the fact set. Fact entity column name 254 identifies the entity the fact set is about. For example, the fact set could be about a participant, a physician or a medical group. Refresh period 256 allows the setting of the refresh period for the fact set. Fact set description 258 contains a simplified description of the fact set. “Days to save” 260 indicates a period of time to retain a snapshot of the fact set in an archive. Versions 262 allow the entry of the number of versions of a particular fact set to save.

Fact set area 253 provides for the designation of specific facts for inclusion within the fact set. The facts to be included are set by fact name 264.

Public name 266 is shown as well as description 268. Data type 270 indicates whether the fact is a number, date, text, etc. Entity 272 indicates is the same as fact entity column name 254.

Fact type 274 indicates where the fact is a fact formula, fact filter or a fact column. Fact category 276 indicates the category. Data pixels 278 shows the pixels required to display the fact. Fact column name pixels 280 is the number of pixels required to display the fact column name. Similarly, public name pixels 282 is the number of pixels required to display the public name.

When fact name 264 is displayed, the other boxes within the row for that fact are automatically populated. Persons defining the facts are allowed to modify the various elements of a fact from fact set tool 250.

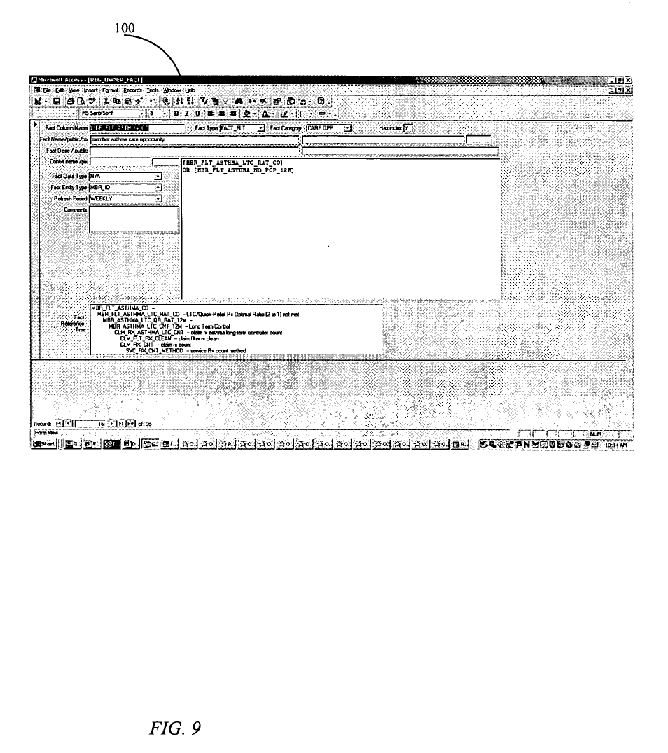

FIG. 9 shows a further extension of tool 100. The tool has been expanded further by providing an extension to the SQL programming language. SQL may reference other formula or filter facts by enclosing their names in square brackets. For example the fact MBR_FLT_ASTHMA_CO refers to another fact called MBR_FLT_ASTHMA_LTC_RAT_CO in square brackets. During the refresh of the database, the application performing the refresh will look up the SQL for the referenced fact and insert it at run time. This feature allows standard queries to be written using “canned” pieces. If many facts need to reference the same filter criteria, for example, then it can be written once and referred to many times.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A fact within a database comprising:
information; and
a reference depth attribute.

2. The fact of claim 1 further comprising:
a display attribute.

3. The fact of claim 2 further comprising:
a name attribute.
